(19) United States
(12) Patent Application Publication
(10) Pub. No.: US 2024/0313312 A1
(43) Pub. Date: Sep. 19, 2024

(54) ARCHITECTURE FOR BATTERY PACKS

(71) Applicant: BAE Systems Controls Inc., Endicott, NY (US)

(72) Inventors: Michael Mallery, Apalachin, NY (US); Joshua J. Hammond, Montrose, PA (US); Ryan J. Klein, Endwell, NY (US); Roland T. Bates, Apalachin, NY (US); Matthew K. Jaspersen, Endicott, NY (US); Samuel G. Olsen, Binghamton, NY (US)

(73) Assignee: BAE Systems Controls Inc., Endicott, NY (US)

(21) Appl. No.: 18/121,241

(22) Filed: Mar. 14, 2023

(51) Int. Cl. H01M 50/204; H02J 7/00

(52) U.S. Cl. CPC H01M 50/204; H02J 7/00043; H02J 7/0013

(57) ABSTRACT

A battery assembly includes an enclosure, and a plurality of battery modules within the enclosure. Each battery module includes an array of battery cells, one or more first sensors configured to measure one or more first parameters of the corresponding battery module, and a first processor configured to receive sense signals from the one or more first sensors of the corresponding battery module. One or more second sensors are within the enclosure, but external to the battery modules, and configured to measure one or more second parameters of the battery assembly. A second processor within the enclosure is to receive data from each of first processors and the one or more second sensors, and transmit controller input data to a controller external to the battery assembly, the controller input data based on the data received from the first processors and the one or more second sensors.

### TECHNICAL FIELD

The present disclosure relates generally to battery technology, and more particularly to architecture for battery assemblies.

### BACKGROUND

A battery is a popular source of electric power, e.g., providing direct current (DC) to a load. A battery has a positive terminal or cathode, and a negative terminal or anode. Multiple batteries can be coupled in series and/or parallel, to form a high voltage and/or high power DC power source.

Rechargeable batteries can be charged and discharged, and such charge and discharge cycles can occur multiple times over a life of a battery. For example, once the battery is discharged while in use, the battery can be recharged using an applied electric current, during which an original composition of the battery electrodes may be fully or at least partially restored by reverse current. Examples of such rechargeable batteries include lead-acid batteries and lithium-ion batteries. Batteries can be used for any number of applications, such as used in consumer electronic devices, wearable devices, computers, electrical and non-electric vehicles, and/or many other devices or systems that use DC power.

### BRIEF DESCRIPTION OF THE DRAWINGS

FIG. 1 illustrates a battery assembly comprising a plurality of battery modules, each battery module comprising a corresponding plurality of battery cells extending laterally between two corresponding cold plates, wherein the battery assembly is within an enclosure, in accordance with an embodiment of the present disclosure.

FIG. 2 illustrates a system including the battery assembly of FIG. 1, where the battery assembly supplies power to a load, in accordance with an embodiment of the present disclosure.

FIG. 3 illustrates a system that is at least in part similar to the system of FIG. 2, where the system of FIG. 3 includes multiple battery assemblies supplying power to corresponding loads, in accordance with an embodiment of the present disclosure.

FIG. 4 illustrate a flowchart depicting a method for operating the battery assembly of FIGS. 1-3 and the battery system of FIGS. 2 and 3, in accordance with an embodiment of the present disclosure.

The figures depict various embodiments of the present disclosure for purposes of illustration only and are not necessarily drawn to scale. Numerous variations, configurations, and other embodiments will be apparent from the following detailed discussion.

### DETAILED DESCRIPTION

A battery system and related techniques are described. In an example, the system comprises a battery assembly within an enclosure. The battery assembly includes a plurality of battery modules, where each battery module comprises (i) an array of battery cells, (ii) one or more module-level sensors configured to measure one or more module-level parameters of the corresponding battery module, and (iii) a module-level processor configured to receive sense signals from the one or more module-level sensors of the corresponding battery module. The battery assembly further includes an assembly-level processor (e.g., which is external to individual battery modules, and is included within the enclosure of the battery assembly), and one or more assembly-level sensors within the enclosure and configured to measure one or more assembly-level parameters of the battery assembly. The assembly-level processor may in turn provide data to a controller configured to disconnect the battery assembly from a load, responsive to fault detection.

Note that a “module-level” component is included in each battery module of the battery assembly. In contrast, an “assembly-level” component is external to the battery modules, and may be common to one or more (e.g., all) of the battery modules. Examples of module-level sensors include voltage and temperature sensors within individual battery modules. Examples of assembly-level sensors include an outgas sensor and a pressure relief sensor.

In an example, the module-level processors process sense signals from the corresponding module-level sensors, and transmit information associated with the sense signals, using one or more digital signals and one or more discrete signals, to the assembly-level processor. Transmitting the digital signals and the discrete signals improve reliability of data communication between the module-level processors and the assembly-level processor.

Numerous variations and embodiments will be apparent in light of the present disclosure.

### General Overview

Techniques are described herein to form a battery system including a battery assembly, where the battery system includes redundancies for operation of the battery system. In some examples, sensor data is redundantly communicated using digital signals and discrete signals. Merely as an example where the sensor data is from a temperature sensor, a digital signal may provide the sensed temperature value, a temperature profile over time, a rate of rise of the temperature, a location at which the temperature is sensed, and/or other relevant information about the sensed temperature. In contrast, a discrete signal is indicative of whether the sensed temperature represents an over-temperature fault condition. For example, a discrete signal has two states, such as a “no fault detected” state corresponding to a first voltage level of the discrete signal, and a “fault detected” state corresponding to a second voltage level of the discrete signal. In an example, control signals (e.g., to control switches or contactors of the battery system) may also be communicated using digital and discrete signals, where such a discrete signal has a first state corresponding to a “switch close” mode of a switch, and a second state corresponding to a “switch open” mode of the switch. In an example, the digital signals are transmitted over corresponding digital buses, such as Controller Area Network (CAN) buses. In an example, the discrete signals are transmitted over corresponding discrete buses, which may be appropriate types of analog or discrete buses configured to transmit discrete signals.

In some examples, a battery assembly comprises an enclosure, and a plurality of battery modules within the enclosure. In some such examples, each battery module comprises (i) a corresponding array of battery cells, (ii) one or more corresponding module-level sensors configured to measure one or more corresponding module-level parameters of the corresponding battery module, and (iii) a corresponding module-level processor configured to receive sense signals from the one or more corresponding module-level sensors of the corresponding battery module. Note that a “module-level” component is included in each battery module of the battery assembly. In contrast, an “assembly-level” component is included in the battery assembly but is external to the battery modules, e.g., is common to one or more (e.g., all) of the battery modules.

In some examples, each battery module comprises one or more cold plates. In some such examples, each battery module comprises two corresponding cold plates, and battery cells of the corresponding battery module extends from near a first cold plate to near a second cold plate of the battery module.

In an example, within a battery module, the corresponding module-level processor processes sense signals from the corresponding module-level sensors. Examples of module-level sensors include voltage and temperature sensors within individual battery modules. For example, a module-level processor receives temperature sense signals and voltage sense signals from corresponding temperature and voltage sensors, respectively, and generates digital signals indicative of the sensed temperature and voltage. In one embodiment, the module-level processor also generates discrete signals indicative of whether the corresponding battery module has an over-temperature condition, an over-voltage condition, and/or an under-voltage condition. Thus, the sense data from a sensor is used to generate a corresponding digital signal and a corresponding discrete signal by a module-level processor.

In some examples, the battery assembly further comprises an assembly-level processor and one or more assembly-level sensors. The assembly-level processor and the assembly-level sensors are common to all the battery modules, and may not be included in any of the battery modules. Examples of the assembly-level sensors include an outgas sensor and a pressure relief sensor, as described below.

In one embodiment, the assembly-level processor receives the digital signals and the discrete signals from the plurality of module-level processors, where the digital signals and the discrete signals are indicative of sensor data from the various module-level sensors. Furthermore, in an example, the assembly-level processor also generates additional digital signals and discrete signals for sense signals received from the assembly-level sensors.

In some examples, the battery system includes a controller external to the battery assembly. The controller receives the various digital and discrete signals from the assembly-level processor, where the digital and discrete signals are indicative of the sense signals from the various sensors (such as module-level sensors and assembly-level sensors) of the battery assembly. Receiving sense data via the digital and discrete signals improve redundancy of data communication between the assembly-level processor and the controller.

In one embodiment, the battery assembly is coupled to a load, e.g., through one or more switches. In an example, the switches are contactors. In an example, the controller controls the switches (e.g., using digital and/or discrete control signals), based on the digital and discrete signals received by the controller from the assembly-level processor. For example, responsive to the digital and discrete signals indicating a fault condition within the battery assembly, the controller causes to open at least one of the switches between the battery assembly and the load. In an example, the controller issues a digital control signal and a discrete control signal to a corresponding switch, e.g., to improve redundancy of communication between the controller and the switch, as described below.

In accordance with some embodiments of the present disclosure, these various approaches can be used individually or together to operate a battery system with increased redundancy.

As used herein, the term “about” indicates that the value listed may be somewhat altered or otherwise within an acceptable tolerance, as long as the alteration does not result in nonconformance of the process or device. For example, for some elements the term “about” can refer to a variation of ±0.1%, for other elements, the term “about” can refer to a variation of ±1% or ±10%, or any point therein. As also used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

### Architecture—Battery Assembly

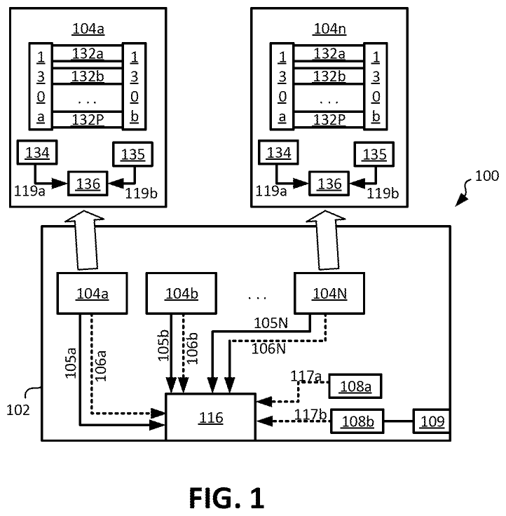

FIG. 1 illustrates a battery assembly 100 comprising a plurality of battery modules 104a, . . . , 104N, each battery module 104 comprising a corresponding plurality of battery cells 132a, . . . , 132P extending laterally between two corresponding cold plates 130a and 130b, wherein the battery assembly 100 is within an enclosure 102, in accordance with an embodiment of the present disclosure.

Thus, the battery assembly 100 (also referred to herein as an assembly 100) comprises N number of battery modules 104a, . . . , 104N, where N is an appropriate positive integer. There may be eight modules, or sixteen modules (e.g., N=8 or 16), for example, although N may have another appropriate value. Example architectures of two example battery modules 104a and 104N are illustrated in FIG. 1, and one or more (e.g., all) of the other battery modules may have similar architecture. An example battery module 104a is described below, and such description, unless otherwise mentioned, also applies to the other battery modules as well.

The battery module 104a comprises one or more cold plates (e.g., comprising one or more metals and/or alloys thereof), such as cold plates 130a and 130b. Although not illustrated, one or more coolant tubes run adjacent to (or through) the cold plates, to keep the cold plates relatively cold (e.g., colder than the battery cells), and facilitate in transfer of heat from the battery cells to the ambient. In an example, the cold plates 130a and/or 130b of the various battery modules can form at least a section of the outer wall of the enclosure 102.

In an example, battery cells 132a, . . . , 132P extend from near one cold plate 130a to near another cold plate 130b, although other layouts of the battery cells relative to the cold plates may also be possible. Thus, in an example, there are P number of battery cells in each battery module 104, where P is an appropriate integer. In another example, each battery module may have unequal or different number of battery cells. In an example, there may be tens, or hundreds of battery cells per battery module 104. Thus, for example, P can range between 10 and 500, although another appropriate value of P may also be possible.

In one embodiment, individual battery cells 132 may comprise of any appropriate type of battery cell. For example, individual battery cells 132 may comprise lithium ion battery cells, although the battery cells 132 may be of another appropriate type, such as lead acid battery cells, or hydrogen cells. In an example, the plurality of battery cells 132a, . . . , 102P of a battery module 104 may be coupled in series and/or parallel connection.

In an example, the battery cells 132a, . . . , 132P may be of appropriate size and may have any appropriate shape or form factor. In one embodiment, each battery cell 132 includes an electrolyte within a corresponding container, although the electrolyte and the containers of the battery cells 132 are not illustrated in FIG. 1.

In one embodiment, each battery module 104 includes one or more temperature sensors 134 and/or one or more voltage sensors 135. For example, FIG. 1 illustrates each of the battery modules 104a and 104N including a temperature sensor 134 and a voltage sensor 135. In an example, sensors within individual battery modules 104 is referred herein as “module-level sensors,” as each of these sensors measure parameters of a corresponding battery module 104 in which the sensor is present. For example, the temperature sensor 134 and the voltage sensor 135 within the module 104a measure the temperature and output voltage of the battery cells of specifically the module 104a; the temperature sensor 134 and the voltage sensor 135 within the module 104N measure the temperature and output voltage of the battery cells of specifically the module 104N; and so on.

In one embodiment, a temperature sensor 134 of a module 104 outputs a sense signal 119a indicative of the sensed temperature. In one embodiment, a voltage sensor 135 of a module 104 outputs a sense signal 119b indicative of the sensed voltage.

In an example, each battery module 104 comprises a corresponding module-level processor 136. For example, FIG. 1 illustrates each of the modules 104a and 104N including a corresponding processor 136. The processor 136 of a module receives sense signals from the corresponding temperature sensor 134 and the corresponding voltage sensor 135 of the corresponding module.

The battery assembly 100 further comprises a processor 116 that is common to each of the modules 104a, . . . , 104N. Thus, the processor 116 is also referred to as an assembly-level processor. In one embodiment, the processor 116 receives sensor data from individual module-level processors 136 of each of the modules 104a, . . . , 104N.

The battery assembly 100 comprises one or more sensors, such as sensors 108a and 108b. The sensors 108a and 108b are common to each of the modules 104a, . . . , 104N, and hence, these sensors are also referred to as assembly-level sensors. In an example, the sensor 108a is an outgas sensor, and the sensor 108b is a pressure relief sensor, as described below.

In an example, the sensor 108a is an outgas sensor. In an example, out-gassing (also sometimes referred to as off-gassing) of a battery cell may occur during a beginning stage of battery failure. When out-gassing of the battery cell occurs, if no actions are taken to remedy the cause of the failure, the battery cell may proceed to thermal runaway, and may even burst into fire. In an example, out-gassing may result from vapor of the battery cell electrolyte and/or other gas(es) generated within the battery cell, e.g., due to a fault condition within the battery cell. In such an example, such vapor and/or gas may be released out of the battery cell. Examples of gases released from battery cells, such as lithium ion battery cells, include hydrogen, methane, ethane, methylene, propylene, carbon monoxide, carbon dioxide, and/or organic carbonates. In an example, the gases released from the battery cells may depend on the electrolyte and/or other materials used within the battery cells, and the type of battery cells (e.g., lithium ion battery cells or another appropriate type of battery cells).

In one embodiment, the outgas sensor 108a is configured to detect an outgas event in one or more battery cells of the plurality of battery cells 132a, . . . , 132P of the various modules 104a, . . . , 104N. For example, the outgas sensor 108a is mounted proximal to the battery cells 132 of the battery modules 104, and the outgas sensor 108a monitors the gas space inside the enclosure 102. The gas(es) monitored by the outgas sensor 108a may be based on the type of the battery cells 132 used in the assembly 100. For example, if the battery cells 132 comprise lithium ion battery cells, then the outgas sensor 108a may monitor for vapor of lithium ion battery electrolyte and/or other gases potentially generated by such a battery cell during a fault condition. The outgas sensor 108a may detect gases from the battery cells 132 in parts per million (ppm) level detection threshold, for example.

In one embodiment, the outgas sensor 108a outputs a sense signal 117a, which may be a discrete sense signal, as described below. Once the outgas sensor 108a detects at least a threshold amount (e.g., a threshold ppm level) of gas leakage from one or more battery cells 132 (e.g., detects an outgas event), the sense signal 117a is indicative of such a detection. For example, upon detecting an outgas event, the sense signal 117a changes from a first signal level to a second signal level.

For example, when no outgas event is detected (e.g., detected outgas is zero or at least less than a threshold outgas level), the outgas sensor 108a may output the sense signal 117a at a first voltage (e.g., 0.50 V DC (direct current)). Upon detecting an outgas event (e.g., detected outgas is equal to or higher than the threshold outgas level), the outgas sensor 108a may output the sense signal 117a at a second voltage level (e.g., 3.0 V DC). Thus, the sense signal 117a provides indication of the outgas event.

The outgas event may be a warning or a failure state of the battery assembly 100. For example, in response to a detection of the outgas event, an operation of the battery assembly 100 may be shut down, as described below.

In one embodiment, during an outgas event, the gas pressure within the enclosure 102 increases, e.g., due to vaporization of the electrolyte of one or more of the battery cells 132 because of a fault condition within the one or more battery cells. In an example, the outgas sensor 108a detects such as outgas event, and indicates such detection through the sense signal 117a. As described below, preventative actions may be taken (e.g., by the processor 116 and other controller external to the battery assembly 100), to remedy the situation causing the outgas event (e.g., by shutting down the battery cells). However, in one example, the outgas detection and/or such remedial actions may not be sufficient or on time, and the gas pressure within the enclosure 102 may rise. Such rising gas pressure may cause thermal runaway, fire hazards, and/or structural damage to the enclosure 102.

Accordingly, in one embodiment, the battery assembly comprises a pressure relief device 109, where the sensor 108b is a pressure relief sensor configured to sense a pressure release event caused by the pressure relief device 109. For example, the pressure relief device 109 within the enclosure 102 releases gas pressure from the enclosure 102, e.g., in response to the gas pressure within the enclosure 102 exceeding a threshold pressure value. In an example, the pressure relief device 109 is a burst disc or rapture disc mounted on a wall of the enclosure 102. A burst disc or a rupture disk is a pressure relief safety device that protects the assembly 100 from over pressurization and consequent fire hazards and/or structural damage. The pressure relief device may be any pressure relief device known in the art and include, as non-limiting examples, safety valves, relief valves, pressure relief valves, and safety relief valves. For example, the pressure relief device 109 has a non-reclosing, sacrificial part that is a one-time-use membrane or diaphragm. The diaphragm fails or ruptures at or above a predetermined differential pressure between the inside of the enclosure 102 and the ambient. For example, when the gas pressure inside of the enclosure 102 exceeds a threshold pressure, the diaphragm fails or ruptures (referred to herein as a pressure release event), thereby rapidly releasing the gas from within the enclosure 101, and thereby releasing or reducing the gas pressure within the enclosure 101. For example, the pressure relief device 109, when activated or ruptured, reduces the pressure within the enclosure 102 within a relatively small amount of time (e.g., within seconds or milliseconds or microseconds). In an example, once the diaphragm bursts, it may not be resealed, and the pressure relief device 109 may become non-operational until the diaphragm is repaired or replaced.

In one embodiment, the pressure relief sensor 108b senses a pressure release event caused by the pressure relief device 109. For example, the pressure relief sensor 108b outputs a sense signal 117b indicative of the pressure release event. In an example, the sense signal 117b may be a discrete sense signal, as described below. In an example, the pressure relief sensor 108b may be integrated with the pressure relief device 109. For example, a rupture of the diaphragm of the pressure relief device 109 may be detected by the pressure relief sensor 108b.

For example, when no pressure release event is detected, the pressure relief sensor 108b may output the sense signal 117b at a first voltage. Upon detecting a pressure release event, the pressure relief sensor 108b may output the sense signal 117b at a second voltage level. Thus, the sense signal 117b provides indication of the pressure release event.

The pressure release event may be a warning or a failure state of the battery assembly 100. For example, in response to a detection of the pressure release event, operations of the battery assembly 100 may be shut down, as described below.

Note that in an example, the sense signals 117a, 117b are discrete sense signals, and the discrete signals 117a, 117b are illustrated using dotted lines in FIG. 1. For example, each of the sense signals 117a, 117b has two states. For example, a low value of the sense signal 117a implies that no outgas event (e.g., no warning or fault condition) has been detected, and a high value of the sense signal 117a implies that an outgas event (e.g., a warning or a fault condition) has been detected. Similarly, a low value of the sense signal 117b implies that no pressure relief event (e.g., no warning or fault condition) has been detected, and a high value of the sense signal 117b implies that a pressure relief event (e.g., a warning or a fault condition) has been detected.

As described above, that the sense signals 117a, 117b are discrete signals. In contrast, in an example, the temperature sense signal 119a detected by the temperature sensor 134 of each module 104 and/or the voltage sense signal 119b detected by the voltage sensor 135 of each module 104 are analog signals. For example, a voltage value of the temperature sense signal 119a is representative of a sensed temperature, and a voltage value of the voltage sense signal 119b is representative of a sensed voltage.

As described above, within a module 104 (such as the module 104a), the corresponding processor 136 receives the analog temperature sense signal 119a and the analog voltage sense signal 119b. For each module 104, the corresponding processor 136 generates and transmits one or more digital signals 105 and one or more discrete signals 106 to the processor 116. For example, the processor 104a of the module 104a transmits one or more digital signals 105a and one or more discrete signals 106a to the processor 116, the processor 104b of the module 104b transmits one or more digital signals 105b and one or more discrete signals 106b to the processor 116, the processor 104N of the module 104N transmits one or more digital signals 105N and one or more discrete signals 106N to the processor 116, and so on. In FIG. 1, discrete signals 106a, 106b, . . . , 106N are illustrate using dotted lines.

For example, in an example module 104a, the corresponding processor 136 receives the analog temperature sense signal 119a from the temperature sensor 134 indicative of the temperature of the module 104a. The processor 136 compares the sensed temperature to a threshold temperature, to determine if an over-temperature (or an under-temperature) condition exists within the module 104a. In an example, the discrete signal 106a may be representative of whether an over-temperature (or an under-temperature) event has occurred. Thus, for example, a high level of the discrete signal 106a may indicate an occurrence of an over-temperature event, and a low level of the discrete signal 106a may indicate that an over-temperature event has not been detected.

In another example, in the example module 104a, the corresponding processor 136 receives the voltage sense signal 119b from the voltage sensor 135 indicative of the voltage of the module 104a. The processor 136 compares the sensed voltage to a high threshold voltage, to determine if an over-voltage condition has occurred in the battery cells 132 of the module 104a. Similarly, the processor 136 compares the sensed voltage to a low threshold voltage, to determine if an under-voltage condition has occurred in the battery cells 132 of the module 104a.

In an example, the discrete signals 106a may be a combination of multiple discrete signals. For example, a first one of the discrete signals 106a may be representative of whether the over-temperature event has occurred within the module 104a. Similarly, a second one of the discrete signals 106a may be representative of whether the over-voltage event has occurred within the module 104a. Similarly, a third one of the discrete signals 106a may be representative of whether the under-voltage event has occurred within the module 104a. Similarly, a fourth one of the discrete signals 106a may be representative of whether the under-temperature event has occurred within the module 104a.

In one embodiment, the processor 136 of a module 104a may also transmit one or more digital signals 105a including information associated with the sense signals 119a, 119b to the processor 116. In an example, the digital signals 105a, 105b, . . . , 105N are transmitted over corresponding digital buses, such as Controller Area Network (CAN) buses, although any other appropriate digital communication protocols may also be used.

For example, the processor 136 of the module 104a processes the corresponding sense signals 119a, 119b, and generates the digital signals 105a (similarly, the processor 136 of the module 104b processes the corresponding sense signals 119a, 119b, and generates the digital signals 105b, and so on). For example, appropriate software executing within the processor 136 processes the corresponding sense signals 119a, 119b of the module, and generates the digital signals 105a.

The digital signals 105a may include information about the temperature and/or the voltage sensed by the sensors 134, 135 of the module 104a, the digital signals 105b may include information about the temperature and/or the voltage sensed by the sensors 134, 135 of the module 104b, and so on. For example, the digital signals 105a may include the actual detected temperature and/or voltage, a temperature and/or voltage profile over time, a rate of rise of the temperature and/or voltage, and/or other relevant information about the sensed temperature and/or voltage.

In another example, the temperature sensor 134 may measure temperature of multiple locations within the module 104a (e.g., may comprise more than one underlying temperature sensor). If any of these temperatures go above the above discussed threshold temperature, the discrete signal 106a may transition to a warning/failure state, but may not identify a location of the multiple locations for which the temperature has exceeded the threshold temperature and/or may not identify the actual temperature. In contrast, the digital signal 105a may identify temperature of each of such multiple locations.

Similarly, in an example, for the voltage sense signal 119b, the digital signal 105a may include the actual detected voltage, and/or other relevant information about the sensed voltage. For example, the voltage sensor 135 may measure voltages of multiple groups of battery cells within the module 104a. If, in an example, any of these voltages go below (or above) the low threshold voltage (or above the high threshold high voltage), the discrete under-voltage (or over-voltage) sense signal 106a may transition to a warning/failure state, but may not identify which group of cells has the under-voltage (or over-voltage) condition, or the actual value of the voltage. In contrast, the digital signal 105a may identify the actual voltages of each such groups of battery cells, in an example.

Thus, the processor 136 of each of the modules 104 communicates with the assembly-level processor 116 over a digital communication bus (e.g., the digital signals 105a) and over a discrete signal communication bus (e.g., the discrete signals 105b). Thus, the assembly-level processor 116 receives sensor data via two independent and different communication paths from the module-level processors 136. This improves reliability of communication between the processors 136 and the processor 116. For example, if the processor 136 of the module 104a is unable to generate the digital signals 105a from the sense signals 119a, 119b, the processor 136 of the module 104a may still be able to transmit the discrete signals 106a. Thus, communicating sensor data via two independent and different communication paths from the processors 136 to the processor 116 improves reliability and redundancy of sensor data communication, in an example.

### Example Systems

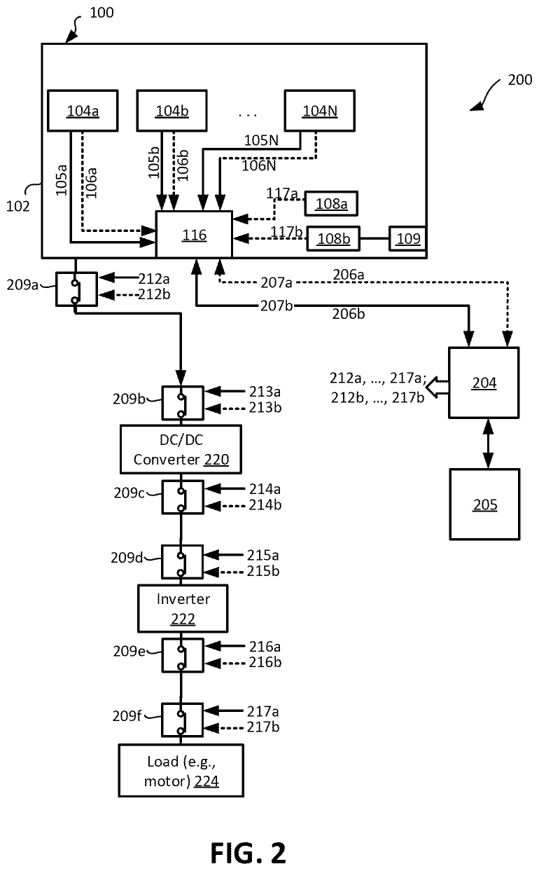

FIG. 2 illustrates a system 200 including the battery assembly 100 of FIG. 1, where the battery assembly 100 supplies power to a load 224, in accordance with an embodiment of the present disclosure. The system 200 comprises a controller 204 external to the battery assembly 100, where the controller 204 is in communication with the processor 116 of the assembly 100.

For example, the processor 116 communicates with the controller 204 over a discrete communication bus 207a communicating discrete signals 206a, and also over a digital communication bus 207b communicating digital signals 206b. In an example, the digital communication bus 207b is a CAN bus.

The discrete communication bus 207a is illustrated to be a two way communication bus. However, in another example, the two way communication bus 207a can be replaced by two one-way discrete communication buses (e.g., signals transmit in a single direction only), one for transmitting discrete signals from the processor 116 to the controller 204, and another for transmitting discrete signals from the controller 204 to the processor 116.

In one embodiment, the processor 116 transmits discrete signals over the discrete communication bus 207a, where the discrete signals are indicative of whether one or more warning or fault events have occurred (such as an over temperature event, an over or under voltage event, an outgas event, a pressure release event, and/or another appropriate type of fault event). For example, a high value of a discrete signal may indicate an occurrence of a fault event, and a low value of the discrete signal may indicate that a fault event has not been sensed by a corresponding sensor.

In one embodiment, the digital signals 206b communicated over the communication bus 207b provides digital information about various parameters sensed by the various sensors of the battery module, e.g., as discussed with respect to the digital signals 105a, . . . , 105N. For example, the digital signals 206b may include temperature readings, voltage readings, ppm level of outgases detected by the outgas sensor 108a, a pressure sensed by the pressure relief sensor 108b, and/or other appropriate information associated with outputs of various sensors of the assembly 100.

In an example, the processor 116 retransmits the digital signals 105a, . . . , 105N, or transmits, via communication bus 207b, a summarized or combined version of the digital signals 105a, . . . , 105N, as digital signals 206b to the controller 204. In an example, the processor 116 retransmits the discrete signals 106a, . . . , 106N, or transmits, via communication bus 207a, a summarized or combined version of the discrete signals 106a, . . . , 106N, as discrete signals 206a to the controller 204. For example, instead of retransmitting individual discrete signals 106a, . . . , 106N, the processor 116 may transmit a single discrete signal 206a that is representative of the discrete signals 106a, . . . , 106N. For example, if one or more of the discrete signals 106a, . . . , 106N indicate a fault condition, the discrete signal 206a would indicate a fault condition. If none of the discrete signals 106a, . . . , 106N indicate a fault condition, the discrete signal 206a would not indicate a fault condition.

The processor 116 may also transmit other relevant information about the battery to the controller 204. For example, the processor 116 may determine a magnitude of energy that the battery assembly 100 can release to a load 224, and the processor 116 may transmit such information to the controller 204 using the digital signals 206b.

In another example, the processor 116 may determine a magnitude of energy that the battery assembly 100 can absorb (e.g., during a charging phase, and/or during a phase in which the load 224 acts as a generator and transmits energy back to the battery assembly 100), and the processor 116 may transmit such information to the controller 204 using the digital signals 206b.

In one embodiment, the system 200 comprises a DC/DC converter 220 receiving DC power from the battery assembly 100, e.g., through switches 209a and 209b. For example, the switch 209a is proximal to the battery assembly 100 (may even be included or be a part of the battery assembly 100), and the switch 209b is proximal to the DC/DC converter 220 (may even be included or be a part of the DC/DC converter 220). In an example, the DC/DC converter 220 acts to step or step down the voltage level of the DC voltage from the battery assembly 100.

In one embodiment, the system 200 further comprises an inverter 222 that receives DC power from the battery assembly 100 through the DC/DC converter 220. In an example, the inverter 222 converts the DC power from the converter 220 to AC power, which is supplied to a load 224. In an example, the load 224 is a motor. Note that in an example, the DC/DC converter 220 may be absent, e.g., in case no DC voltage conversion is to be used. Similarly, in an example, the inverter 222 may be absent, e.g., in case where the load 224 may receive DC voltage.

The system 200 further includes switches 209c and/or 209d between the DC/DC converter 220 and the inverter 222, and switches 209e and/or 209f between the inverter 222 and the load 224. Thus, there are switches 209a, 209b, 209c, 209d, 209e, and 209f between the battery assembly 100 and the load 224. The switches 209a, . . . , 209f are, for example, contactors or other appropriate type of switches.

In an example, each switch is controlled by a corresponding digital control signal (illustrated using non-dotted lines) and/or a corresponding discrete signal (illustrated using dotted lines). In an example, the control signals are generated by controller 204. For example, switch 209a is controlled by digital control signal 212a and/or by discrete control signal 212b; switch 209b is controlled by digital control signal 213a and/or by discrete control signal 213b; switch 209c is controlled by digital control signal 214a and/or by discrete control signal 214b; switch 209d is controlled by digital control signal 215a and/or by discrete control signal 215b; switch 209e is controlled by digital control signal 216a and/or by discrete control signal 216b; and switch 209f is controlled by digital control signal 217a and/or by discrete control signal 217b, as illustrated in FIG. 2.

The digital control signals 212a, 213a, . . . , 217a can be transmitted, for example, over corresponding digital buses, such as CAN buses, or wirelessly using an appropriate wireless protocol (e.g., Bluetooth, or Wi-Fi). On the other hand, discrete control signals 212a, 212b, . . . , 217b can be transmitted over corresponding discrete buses (such as analog signal buses), or wirelessly. Transmitting the same information over a digital bus and a discrete bus to a switch increases a reliability and redundancy of information transmission to the switch.

In one embodiment, the control signals 212a, . . . , 217a, 212b, . . . , 217b are generated, in an example, by the controller 204, e.g., at least in part responsive to the signals 206a and/or 206b. For example, upon detection of a fault condition within the battery assembly 100 (e.g., based on monitoring the discrete signals 206a and/or the digital signals 206b), the controller 204 issues command (e.g., via the control signals 212a, . . . , 217a, 212b, . . . , 217b) to open one or more of the switches 209 of the system 200.

For example, during normal operation of the system 200, the switches 209a, . . . , 209f are in closed or conduction state, and the battery assembly 100 is supplying power to the load 224, e.g., through the switches 209a, . . . , 209f, the converter 220, and the inverter 222. However, one or more fault conditions may arise in the battery assembly 100. The fault condition(s) may be an under-voltage condition, an over-voltage condition, an over-temperature condition, an outgassing event, and/or a pressure release event, e.g., detected by one or more of the sensors 108a, 108, 134, 135 described above with respect to FIG. 1. There may be one or more addition sensors for detecting one or more additional fault conditions, such as over-current fault condition, over-charging fault condition, under-charging fault condition, under-temperature fault condition, for example. The discrete signals 206a and/or the digital signals 206b from the processor 116 to the controller 204 may provide the indication of the fault condition(s).

In one embodiment, responsive to the signals 106a and/or 206b being indicative of one or more such fault conditions, the controller 204 transitions one or more of the control signals 212a, . . . , 217a, 212b, . . . , 217b, to cause one or more of the switches 209a, . . . , 209f to transition from the closed state (conducting) to an open or disconnected state (not conducting or otherwise not passing energy). In an example, the controller 204 is a fault detection and mitigation controller that monitors a health of the battery assembly 100, monitors the battery assembly 100 for fault conditions, and mitigates any detected fault condition(s) by issuing the control signals 212a, . . . , 217a, 212b, . . . , 217b to correspondingly open one or more of the switches 209a, . . . , 209f and disconnecting the battery assembly 100 from the load 224.

In one embodiment, the system 200 includes a component 205, which may be a human interactive component (such as a cockpit display of an aircraft) or an engineering work-station. A human (such as a pilot of the aircraft) can interact with the component 205, and monitor for the fault conditions described above. For example, instead of, or in addition to, the controller 204 automatically issuing the command to open one or more of the switches 209a, . . . , 209f, the human interacting with the component 205 may also manually issue the command to open one or more of the switches 209a, . . . , 209f As describe above, the command to open one or more of the switches 209a, . . . , 209f may be in the form on digital control signals 212a, . . . , 217a and/or discrete signals 212b, . . . , 217b.

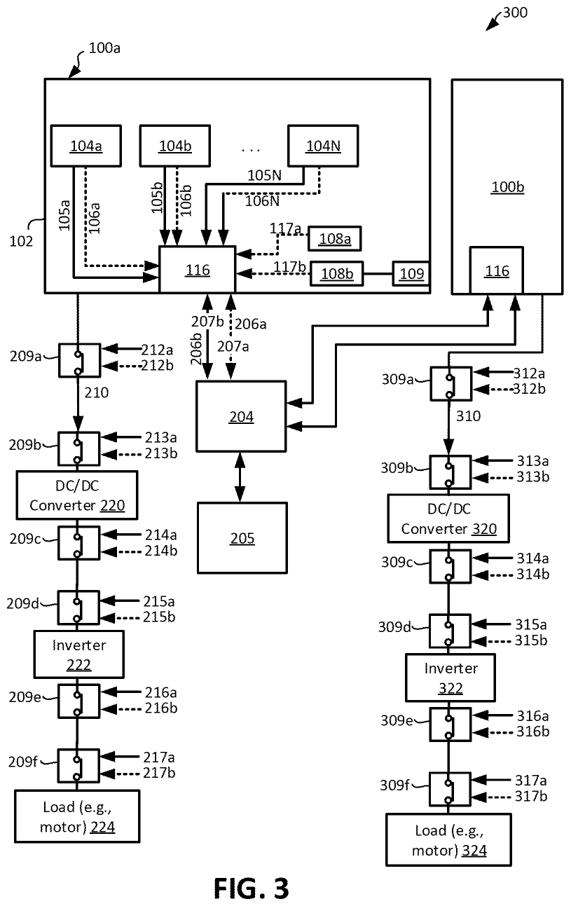

FIG. 3 illustrates a system 300 that is at least in part similar to the system 200 of FIG. 2, where the system 300 of FIG. 3 includes multiple battery assemblies 100a, 100b supplying power to corresponding loads 224, 324, in accordance with an embodiment of the present disclosure. For example, the system 200 of FIG. 2 included a single battery assembly 100 of FIG. 1. In contrast, the system 300 of FIG. 3 includes a first battery assembly 100a and a second battery assembly 100b, each of which may be similar to the battery system 100 of FIG. 1. Although some of the components of the battery assembly 100a is illustrate in FIG. 3, only a processor 116 of the battery assembly 100b is illustrated in FIG. 3.

As illustrated, the battery assembly 100b supplies power to a load 324 through a DC/DC converter 320, an inverter 322, and switches 309a, . . . , 309f, each of which is similar to the corresponding components of the system 200 of FIG. 2. Furthermore, similar to FIG. 2, the switches 309a, . . . , 209f are controlled by digital signals 312a, . . . , 317a, and/or discrete signals 312b, . . . , 317b issued by the controller 204, as illustrated in FIG. 3. FIG. 3 will be apparent, based on the discussion with respect to FIG. 2.

### Methodology

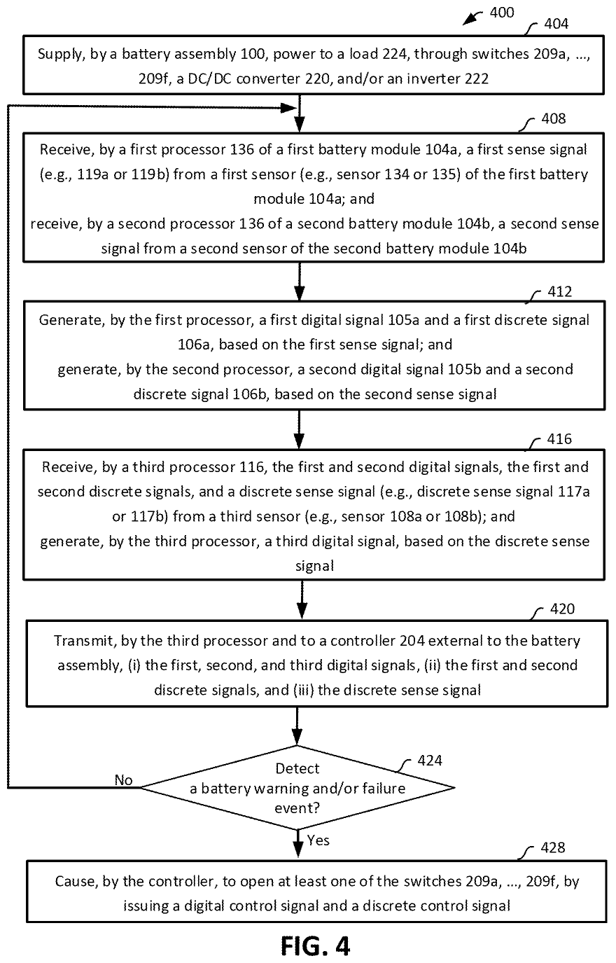

FIG. 4 illustrate a flowchart depicting a method 400 for operating the battery assembly 100 of FIGS. 1-3 and the battery system 200 and 300 of FIGS. 2 and 3, in accordance with an embodiment of the present disclosure.

At 404 of the method 400, a battery assembly 100 supplies power to a load 224, e.g., through one or more of the switches 209a, . . . , 209f, a DC/DC converter 220, and/or an inverter 222, as illustrated in FIGS. 2 and 3.

The method 400 proceeds from 404 to 408, where a first processor 136 of a first battery module 104a receives a first sense signal (e.g., any of the sense signals 119a or 119b) from a first sensor (e.g., a corresponding one of sensors 134 or 135) of the first battery module 104a. Similarly, a second processor 136 of a second battery module 104b receives a second sense signal from a second sensor of the second battery module 104b, as described above with respect to FIG. 1.

The method 400 proceeds from 408 to 412, where the first processor generates a first digital signal 105a and a first discrete signal 106a, based on the first sense signal. Similarly, the second processor generates a second digital signal 105b and a second discrete signal 106b, based on the second sense signal, as described above with respect to FIG. 1.

The method 400 proceeds from 412 to 416, where a third processor 116 receives the first and second digital signals 105a, 105b, the first and second discrete signals 106a, 106b, and a discrete sense signal (e.g., any of the discrete sense signals 117a or 117b) from a third sensor (e.g., any of the sensors 108a or 108b). In an example, the third processor 116 is within the battery assembly 100 and is external to each of the first battery module and the second battery module, as shown. Also, at 416, the third processor 116 generates a third digital signal, based on the discrete sense signal 117a or 117b. In this manner, the digital signal generated by the third processor 116 corresponds to the discrete sense signal 117a or 117b.

The method 400 proceeds from 416 to 420, where the third processor transmits, to a controller 204 that is external to the battery assembly, (i) the first, second, and third digital signals, (ii) the first and second discrete signals, and (iii) the discrete sense signal. For example, the first, second, and third digital signals are transmitted as digital signals 206b. The first and second discrete signals and the discrete sense signal are transmitted as discrete signals 206a, as described above with respect to FIG. 2.

The method 400 proceeds from 420 to 424, where the controller 204 detects if a battery warning and/or failure event has occurred, e.g., based on monitoring (i) the first, second, and third digital signals, (ii) the first and second discrete signals, and (iii) the discrete sense signal, as described above with respect to FIG. 2.

If “No” at 424 (e.g., no battery warning and/or failure event has been detected), the method 400 loops back at 408, where the controller 204 continues to perform the monitoring (408-420) and detection (424). Note that the operations at 404, 408, 412, 416, and 420 occur continuously during regular or normal operation of the battery assembly 100, e.g., until a positive detection has been made at 424.

If “Yes” at 424 (e.g., a battery warning and/or failure event has been detected), the method 400 proceeds from 424 to 428. At 428, the controller 204 causes to open at least one of the switches 209a, . . . , 209f, by issuing a digital control signal and a discrete control signal, as described above with respect to FIG. 2.

Note that the processes in method 400 are shown in a particular order for ease of description. However, one or more of the processes may be performed in a different order or may not be performed at all (and thus be optional), in accordance with some embodiments. Numerous variations on method 400 and the techniques described herein will be apparent in light of this disclosure.

### FURTHER EXAMPLES

The following examples pertain to further embodiments, from which numerous permutations and configurations will be apparent.

Example 1. A battery assembly comprising: an enclosure; first and second battery modules within the enclosure, wherein each of the first battery module and the second battery module comprises (i) an array of battery cells, (ii) a first sensor configured to measure a first parameter of the corresponding battery module, and (iii) a first processor configured to receive first sensor data from the first sensor of the corresponding battery module; a second sensor within the enclosure and configured to measure a second parameter of the battery assembly, the second sensor external to the first and second battery modules; and a second processor within the enclosure and configured to (i) receive first processor data from the first processor of the first battery module and from the first processor of the second battery module, (ii) receive second sensor data from the second sensor, and (iii) transmit controller input data to a controller external to the battery assembly, the controller input data based on (A) the first processor data from the first processors of the first and second battery modules and (B) the second sensor data.

Example 2. The battery assembly of example 1, wherein the first processor of the first battery module is configured to: generate a discrete signal and a digital signal, based on a sense signal received from the first sensor of the first battery module; and transmit, as the first processor data from the first processor of the first battery module, the discrete signal and the digital signal to the second processor.

Example 3. The battery assembly of example 2, wherein the discrete signal is indicative of whether the sense signal indicates a fault condition, and wherein the digital signal is indicative of a value of the first parameter represented by the sense signal.

Example 4. The battery assembly of example 3, wherein one of: the first parameter is a voltage output by the array of battery cells of the first battery module, and the fault condition is an under-voltage condition or an over-voltage condition; or the first parameter is a temperature, and the fault condition is an over-temperature condition.

Example 5. The battery assembly of any one of examples 1-4, wherein the data received by the second processor from the second sensor is in the form of a discrete sense signal received from the second sensor, wherein a first state of the discrete sense signal is indicative of a fault condition, and a second state of the discrete sense signal is indicative of no fault condition being sensed.

Example 6. The battery assembly of example 5, wherein the fault condition is at least one of: an outgassing event in which outgas beyond a threshold level is detected within the battery assembly; or a pressure release event in which a pressure relief device within the enclosure has released gas pressure from the enclosure.

Example 7. A system comprising: a battery assembly comprising (i) a plurality of battery cells, (ii) a sensor configured to measure a parameter within the battery assembly and generate sensing data, and (iii) a processor configured to transmit a first discrete signal and a first digital signal to a controller, wherein the first discrete signal and the first digital signal are based on the sensing data; the controller external to the battery assembly; a load, wherein the battery assembly is configured to supply power to the load; and a switch between the battery assembly and the load; wherein the controller is configured to, responsive to the first discrete signal and/or the first digital signal being indicative of a fault condition within the battery assembly, transmit a second discrete signal and a second digital signal to the switch, to cause the switch to disconnect the load from the battery assembly.

Example 8. The system of example 7, wherein the switch is a first switch, and wherein the system further comprises: a voltage converter to receive a first voltage from the battery assembly, and output a second voltage, wherein the voltage converter is coupled between the battery assembly and the load; and a second switch, wherein the first switch is between the battery assembly and the voltage converter, and wherein the second switch is between the voltage converter and the load.

Example 9. The system of example 8, wherein the controller is further configured to, responsive to the first discrete signal and/or the first digital signal being indicative of the fault condition within the battery assembly, transmit a third discrete signal and a third digital signal to the second switch, to cause the second switch to disconnect the load from the voltage converter.

Example 10. The system of any one of examples 7-9, wherein the sensor is a first sensor, the processor is a first processor, the sensing data is first sensing data, and wherein battery assembly comprises: a first battery module comprising (i) a first cold plate, (ii) a first subset of the plurality of battery cells arranged adjacent to the first cold plate, (iii) the first sensor, and (iv) a second processor configured to receive the first sensing data from the first sensor; and a second battery module comprising (i) a second cold plate, (ii) a second subset of the plurality of battery cells arranged adjacent to the second cold plate, (iii) a second sensor, and (iv) a third processor configured to receive second sensing data from the second sensor.

Example 11. The system of example 10, wherein the first battery module further comprises a third cold plate, and wherein individual battery cells of the first subset of the plurality of battery cells extend laterally from near the first cold plate to near the third cold plate.

Example 12. The system of any one of examples 10-11, wherein the second processor is configured to generate the first discrete signal and the first digital signal, and transmit the first discrete signal and the first digital signal to the first processor.

Example 13. The system of any one of examples 10-12, wherein the first battery module, the second battery module, and the processor are within an enclosure.

Example 14. The system of example 13, wherein the parameter is a first parameter, and wherein the system further comprises: a third sensor within the battery assembly and external to each of the first battery module and the second battery module, the third sensor configured to (i) measure a second parameter, (ii) generate a third discrete signal indicative of the second parameter, and (iii) transmit the third discrete signal to the first processor.

Example 15. The system of example 14, wherein the third sensor is one of (i) an outgas sensor configured to sense an outgas event of one or more battery cells of the plurality of battery cells, or (ii) a pressure relief sensor indicative of whether a pressure relief device within the enclosure has released gas pressure from the enclosure.

Example 16. The system of any one of examples 10-15, wherein the first sensor is one of (i) a voltage sensor configured to sense a voltage of one or more battery cells of the first subset of the plurality of battery cells of the first battery module, or (ii) a temperature sensor to measure a temperature of the first battery module.

Example 17. A method comprising: receiving, by a first processor of a first battery module, a first sense signal from a first sensor of the first battery module; generating, by the first processor, a first digital signal and a first discrete signal, based on the first sense signal; receiving, by a second processor of a second battery module, a second sense signal from a second sensor of the second battery module; generating, by the second processor, a second digital signal and a second discrete signal, based on the second sense signal; and receiving, by a third processor that is included within an enclosure of a battery assembly, the first and second digital signals, and the first and second discrete signals, wherein the battery assembly comprises the first battery module, the second battery module, and the third processor.

Example 18. The method of example 17, further comprising: receiving, by the third processor, a discrete sense signal from a third sensor that is within the battery assembly and is external to each of the first battery module and the second battery module; and generating, by the third processor, a third digital signal, based on the discrete sense signal;

Example 19. The method of example 18, further comprising: transmitting, by the third processor and to a controller external to the battery assembly, (i) the first, second, and third digital signals, (ii) the first and second discrete signals, and (iii) the discrete sense signal.

Example 20. The method of example 19, further comprising: causing, by the controller, to open a switch between the battery assembly and a load, responsive to at least one of the first, second, and third digital signals, the first and second discrete signals, and the discrete sense signal being indicative of a fault condition within the battery assembly.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A battery assembly comprising:
an enclosure;
first and second battery modules within the enclosure, wherein each of the first battery module and the second battery module comprises (i) an array of battery cells, (ii) a first sensor configured to measure a first parameter of the corresponding battery module, and (iii) a first processor configured to receive first sensor data from the first sensor of the corresponding battery module;
a second sensor within the enclosure and configured to measure a second parameter of the battery assembly, the second sensor external to the first and second battery modules; and
a second processor within the enclosure and configured to (i) receive first processor data from the first processor of the first battery module and from the first processor of the second battery module, (ii) receive second sensor data from the second sensor, and (iii) transmit controller input data to a controller external to the battery assembly, the controller input data based on (A) the first processor data from the first processors of the first and second battery modules and (B) the second sensor data.

2. The battery assembly of claim 1, wherein the first processor of the first battery module is configured to:
generate a discrete signal and a digital signal, based on a sense signal received from the first sensor of the first battery module; and
transmit, as the first processor data from the first processor of the first battery module, the discrete signal and the digital signal to the second processor.

3. The battery assembly of claim 2, wherein the discrete signal is indicative of whether the sense signal indicates a fault condition, and wherein the digital signal is indicative of a value of the first parameter represented by the sense signal.

4. The battery assembly of claim 3, wherein one of:
the first parameter is a voltage output by the array of battery cells of the first battery module, and the fault condition is an under-voltage condition or an over-voltage condition; or
the first parameter is a temperature, and the fault condition is an over-temperature condition.

5. The battery assembly of claim 1, wherein the data received by the second processor from the second sensor is in the form of a discrete sense signal received from the second sensor, wherein a first state of the discrete sense signal is indicative of a fault condition, and a second state of the discrete sense signal is indicative of no fault condition being sensed.

6. The battery assembly of claim 5, wherein the fault condition is at least one of:
an outgassing event in which outgas beyond a threshold level is detected within the battery assembly; or
a pressure release event in which a pressure relief device within the enclosure has released gas pressure from the enclosure.

7. A system comprising:
a battery assembly comprising (i) a plurality of battery cells, (ii) a sensor configured to measure a parameter within the battery assembly and generate sensing data, and (iii) a processor configured to transmit a first discrete signal and a first digital signal to a controller, wherein the first discrete signal and the first digital signal are based on the sensing data;
the controller external to the battery assembly;
a load, wherein the battery assembly is configured to supply power to the load; and
a switch between the battery assembly and the load;
wherein the controller is configured to, responsive to the first discrete signal and/or the first digital signal being indicative of a fault condition within the battery assembly, transmit a second discrete signal and a second digital signal to the switch, to cause the switch to disconnect the load from the battery assembly.

8. The system of claim 7, wherein the switch is a first switch, and wherein the system further comprises:
a voltage converter to receive a first voltage from the battery assembly, and output a second voltage, wherein the voltage converter is coupled between the battery assembly and the load; and
a second switch, wherein the first switch is between the battery assembly and the voltage converter, and wherein the second switch is between the voltage converter and the load.

9. The system of claim 8, wherein the controller is further configured to, responsive to the first discrete signal and/or the first digital signal being indicative of the fault condition within the battery assembly, transmit a third discrete signal and a third digital signal to the second switch, to cause the second switch to disconnect the load from the voltage converter.

10. The system of claim 7, wherein the sensor is a first sensor, the processor is a first processor, the sensing data is first sensing data, and wherein battery assembly comprises:
a first battery module comprising (i) a first cold plate, (ii) a first subset of the plurality of battery cells arranged adjacent to the first cold plate, (iii) the first sensor, and (iv) a second processor configured to receive the first sensing data from the first sensor; and
a second battery module comprising (i) a second cold plate, (ii) a second subset of the plurality of battery cells arranged adjacent to the second cold plate, (iii) a second sensor, and (iv) a third processor configured to receive second sensing data from the second sensor.

11. The system of claim 10, wherein the first battery module further comprises a third cold plate, and wherein individual battery cells of the first subset of the plurality of battery cells extend laterally from near the first cold plate to near the third cold plate.

12. The system of claim 10, wherein the second processor is configured to generate the first discrete signal and the first digital signal, and transmit the first discrete signal and the first digital signal to the first processor.

13. The system of claim 10, wherein the first battery module, the second battery module, and the processor are within an enclosure.

14. The system of claim 13, wherein the parameter is a first parameter, and wherein the system further comprises:
a third sensor within the battery assembly and external to each of the first battery module and the second battery module, the third sensor configured to (i) measure a second parameter, (ii) generate a third discrete signal indicative of the second parameter, and (iii) transmit the third discrete signal to the first processor.

15. The system of claim 14, wherein the third sensor is one of (i) an outgas sensor configured to sense an outgas event of one or more battery cells of the plurality of battery cells, or (ii) a pressure relief sensor indicative of whether a pressure relief device within the enclosure has released gas pressure from the enclosure.

16. The system of claim 10, wherein the first sensor is one of (i) a voltage sensor configured to sense a voltage of one or more battery cells of the first subset of the plurality of battery cells of the first battery module, or (ii) a temperature sensor to measure a temperature of the first battery module.

17. A method comprising:
receiving, by a first processor of a first battery module, a first sense signal from a first sensor of the first battery module;
generating, by the first processor, a first digital signal and a first discrete signal, based on the first sense signal;
receiving, by a second processor of a second battery module, a second sense signal from a second sensor of the second battery module;
generating, by the second processor, a second digital signal and a second discrete signal, based on the second sense signal; and
receiving, by a third processor that is included within an enclosure of a battery assembly, the first and second digital signals, and the first and second discrete signals, wherein the battery assembly comprises the first battery module, the second battery module, and the third processor.

18. The method of claim 17, further comprising:
receiving, by the third processor, a discrete sense signal from a third sensor that is within the battery assembly and is external to each of the first battery module and the second battery module; and
generating, by the third processor, a third digital signal, based on the discrete sense signal;

19. The method of claim 18, further comprising:
transmitting, by the third processor and to a controller external to the battery assembly, (i) the first, second, and third digital signals, (ii) the first and second discrete signals, and (iii) the discrete sense signal.

20. The method of claim 19, further comprising:
causing, by the controller, to open a switch between the battery assembly and a load, responsive to at least one of the first, second, and third digital signals, the first and second discrete signals, and the discrete sense signal being indicative of a fault condition within the battery assembly.
